(19) United States
(12) Patent Application Publication
(10) Pub. No.: US 2008/0147799 A1
(43) Pub. Date: Jun. 19, 2008

(54) Methods, Systems, And Computer Program Products For Providing Access To A Secure Service Via A Link In A Message

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/609,920

(22) Filed: Dec. 13, 2006

(51) Int. Cl. G06F 15/16

(52) U.S. Cl. 709/206

(57) ABSTRACT

Methods, systems, and computer program products for providing access to a secure service via a link in a message are disclosed. According to one aspect, the subject matter described herein includes a method for providing access to a secure service via a link in a message. The method includes providing a messaging client associated with a messaging service operating on a sending device. The messaging client includes a user interface that presents a set of contact entries. A selection of a contact from the presented set of contact entries is received via the user interface. An identification of a service to be made accessible to the contact is received, where the service is provided by a provider other than the messaging service. Authorization is required for performing the service. Authorization information associated with the service and the contact is generated for authorizing a performing of the service at a request of the contact. A message is generated at the sending device for the contact. The message includes a link for enabling the contact to access the service. The message is sent to the contact via the messaging service. The contact is enabled to access the service using the link and request the performing of the service. The generated authorization information is used to authorize the performing of the service after the contact is authenticated by the messaging service.

### RELATED APPLICATIONS

The present application is related to co-pending U.S. patent application Ser. No. 11/096,764, titled “SYSTEM AND METHOD FOR UTILIZING A PRESENCE SERVICE TO FACILITATE ACCESS TO A SERVICE OR APPLICATION OVER A NETWORK” (Attorney Docket No. 1309/US), filed on Mar. 31, 2005, and U.S. patent application Ser. No. 11/564,470, titled “METHOD FOR INSERTING ADVERTISING INTO A PRESENCE-CLIENT-BASED SERVICE MESSAGE” (Attorney Docket No. 1430/US), filed on Nov. 29, 2006, each commonly owned together with the present application, the entire disclosures of which are each here incorporated by reference.

### BACKGROUND

Current computing devices provide services not only to a user of the device, but also make services accessible to other devices on the same LAN and/or intranet. Such services include sharing photos for viewing on a computer or enforcing security settings for a home. Traditionally, access to these services has been limited. For example, one could only view one's photos at the computer on which they were stored or as indicated from a device on the same LAN and/or intranet. Devices and their services are becoming increasingly capable of communicating with other devices using messaging clients associated with various messaging services, such as instant messaging (IM) and short messaging service (SMS). Therefore, it is desirable to provide easy and secure access to services available via devices having messaging service clients.

Conventional techniques for providing access to services via a device are not easy to deploy and can raise security issues. For example, a conventional method for providing access to a service by a contact of a messaging service, such as an IM service, includes sending he contact an email including a link that is difficult to guess for accessing the service, such as a string including randomly generated characters. Because the link is not widely published and does not contain an obvious pattern, it is unlikely that an unintended contact would access the service using the link. While this method is convenient, it may not be secure because there is no authentication of users seeking access to the service. Any user who obtains the link can gain access to the service.

Another conventional method for providing access to a service by a contact includes providing the contact with a user name and password for use in accessing the service. While this method provides some measure of security, it requires that the device providing the service distribute the authentication information to the contact and perform the authentication, which increases the processing burden on the service-providing device. Moreover, the user names and passwords are typically sent to contacts via unsecured channels, such as in an unencrypted email or IM, and are therefore not completely secure.

Further, many client devices operate behind firewalls. Providing access to a file system behind a firewall for a client outside the firewall, web service, or other service locally accessible to the client device requires skills not possessed by the average user of a client computing device.

Accordingly, a need exists for improved methods, systems, and computer program products for providing access to a secure service to a contact.

### SUMMARY

The subject matter described herein includes methods, systems, and computer program products for providing access to a secure service via a link in a message are disclosed. According to one aspect, the subject matter described herein includes a method for providing access to a secure service via a link in a message. The method includes providing a messaging client associated with a messaging service operating on a sending device. The messaging client includes a user interface that presents a set of messaging service contact entries. A selection of a contact entry from the presented set of contact entries is received via the user interface where the selected contact entry identifies a contact. An identification of a service to be made accessible to the contact is received, where the service is provided by a provider other than the messaging service. Authorization is required for performing the service. Authorization information associated with the service and the contact is generated for authorizing a performing of the service at a request of the contact. A message is generated at the sending device for the contact. The message includes a link for enabling the contact to access the service. The message is sent to the contact via the messaging service. The contact is enabled to access the service using the link and request the performing of the service. The generated authorization information is used to authorize the performing of the service after the contact is authenticated by the messaging service.

According to another aspect, the subject matter described herein includes a system for providing access to a secure service via a link in a message. The system includes a messaging client associated with a messaging service. The messaging client is configured to operate on a sending device. The messaging client includes a user interface that presents a set of messaging service contact entries. The messaging client is configured to receive, via the user interface, a selection of a contact entry from the presented set of contact entries where the selected contact entry identifies a contact, receive an identification of a service to be made accessible to the contact, the service being provided by a provider other than the messaging service, wherein authorization is required for performing the service, generate authorization information associated with the service and the contact for authorizing a performing of the service at a request of the contact, generate a message at the sending device for the contact, the message including a link for enabling the contact to access the service, and send the message to the contact via the messaging service, enabling the contact to access the service using the link and request the performing of the service, where the generated authorization information is used to authorize the performing of the service after the contact is authenticated by the messaging service.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flow chart of an exemplary method for providing access to a secure service via a link in a message according to an embodiment of the subject matter described herein;

FIG. 2 is a system diagram of an exemplary system for providing access to a secure service via a link in a message according to an embodiment of the subject matter described herein;

FIG. 3 is a block diagram showing a detailed view of a messaging client shown in FIG. 2 that provides access to a secure service via a link in a message according to an embodiment of the subject matter described herein; and

FIG. 4 is an exemplary screen display according to the subject matter described herein.

### DETAILED DESCRIPTION

As used herein, the term “messaging client” refers to functionality residing on a sending device for communicating messages to or from another device via a messaging service. A messaging client may be an application/program/computer executable code performed/embodied in software or hardware for communicating with other messaging clients via a messaging service. Communications between messaging clients may occur in real-time. Further, the communications between messaging clients may include presence information indicating the status/availability of other messaging clients. Exemplary messaging clients suitable for use with the present subject matter include a presence client, a publish-subscribe client, an IM client, a multimedia messaging service (MMS) client, an SMS client, an email client, a video messaging client, and a voice messaging client.

As used herein, the term “messaging service” refers to a service for enabling communications between messaging clients wherein communications includes a messaging protocol and supporting services. The communications between messaging clients may include text, voice, images, or other suitable methods for exchanging information. Examples of messaging services include SMS, MMS, IM, email, and voice messaging. Examples of supporting services include presence services, authentication services, and file transfer services. Web portals and internet service providers (ISPs) providing email and/or IM support, for example, are messaging services. The term messaging service contact, or simply contact, is used here to describe principals for which the messaging service clients exchange messages and information. A messaging service principal is typically a human, but principals can include non-human entities, such as other services, devices, program modules, and the like.

As used herein, a service of a client device to which contacts may be provided access includes an application, a system, a function, or other executable instructions processed on a sending device with a messaging client accessing a resource, application, or system or is one of the previous entities accessible to the client, typically via a LAN or intranet. The service is separate from the messaging service through which the service is made available to a contact of the messaging client. Examples of services described herein include a photo sharing service, a file system service, a printer service, and a camera service.

The subject matter described herein may be implemented using a computer readable medium containing a computer program, executable by a machine, such as a computer. Exemplary computer readable media suitable for implementing the subject matter described herein include chip memory devices, disk memory devices, programmable logic devices, application specific integrated circuits, and downloadable electrical signals. In addition, a computer-readable medium that implements the subject matter described herein may be located on a single device or computing platform or may be distributed across multiple devices or computing platforms.

As used herein, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium.

More specific examples (a non-exhaustive list) of the computer readable medium can include the following: a wired network connection and associated transmission medium, such as an Ethernet transmission system, a wireless network connection and associated transmission medium, such as an IEEE 802.11(a), (b), or (g) or a Bluetooth transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital versatile disc (DVD), and the like.

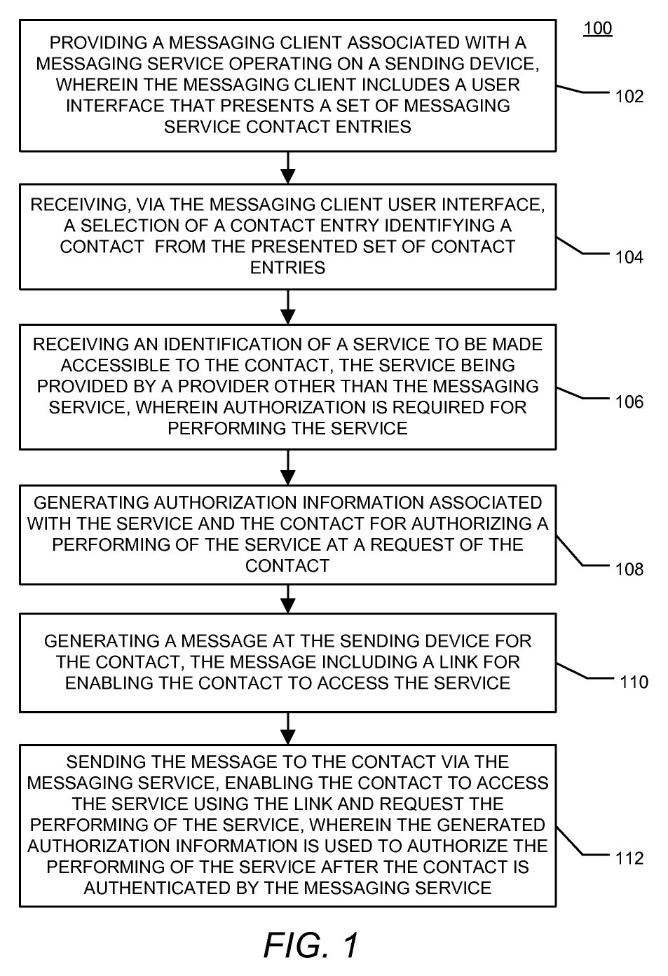

The subject matter described herein includes systems, methods, and computer program products for providing access to a secure service via a link in a message. FIG. 1 depicts a flow chart illustrating an exemplary method 100 for providing access to a service to a contact of a messaging client of a sending device via a link in a message.

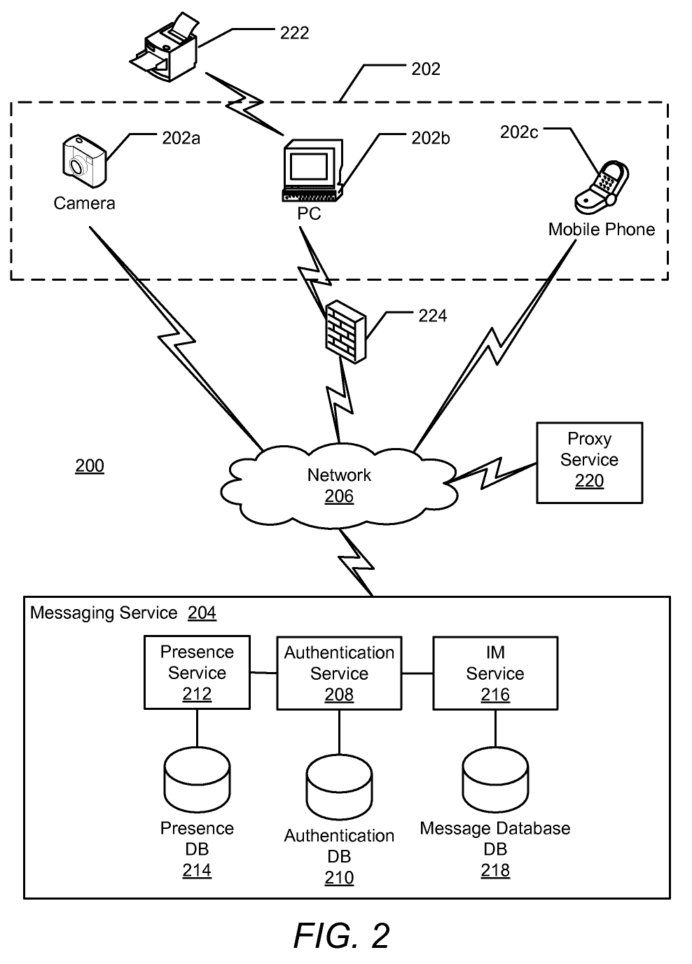

FIG. 2 depicts an exemplary system 200 for providing access to a service to a contact of a messaging client of a sending device via a link in a message. The system 200 is capable of performing the method 100 as will be described. The method 100, therefore, is described in terms of the system 200.

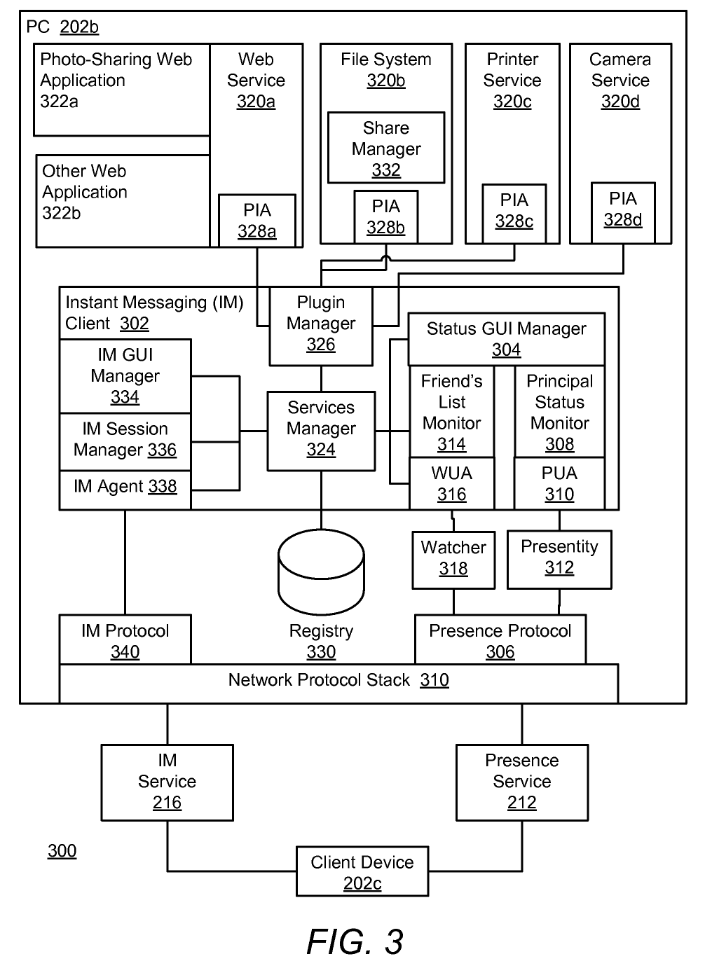

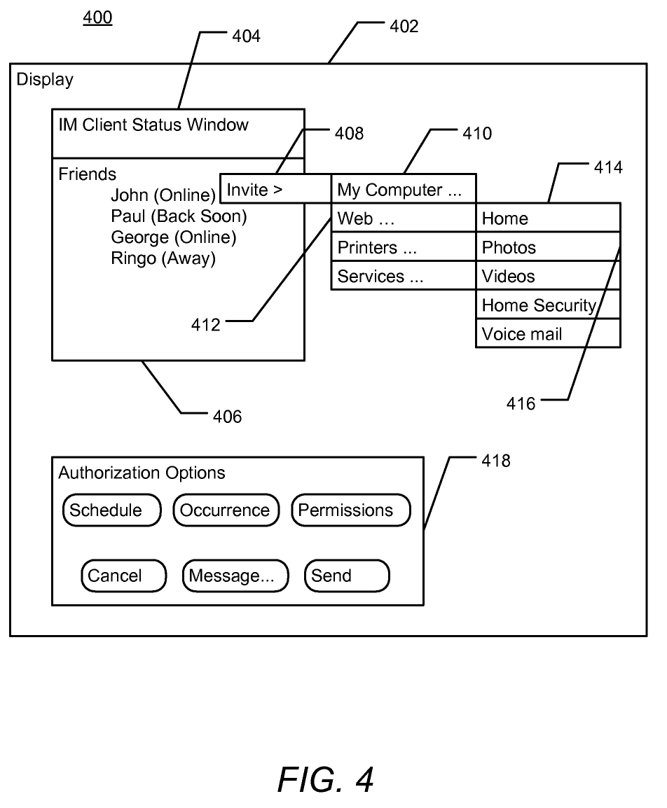

At block 102 of the method 100, a messaging client associated with a messaging service operating on a sending device is provided. The messaging client is associated with a communication devices, such as devices 202 shown in FIG. 2, can include, for example, an IM client associated with a messaging service including an IM server or service, such as the IM client 302 shown in FIG. 3, an email client associated with an email server coupled to the Internet email system, an MMS client associated with a MMS system, and a voice messaging clients integrated with data transfer capabilities and supporting services. Further, the messaging client includes a user interface, such as the user interface 400 shown in FIG. 4, that presents a set of contact entries. The contact entries may be from an address book stored locally or remotely, or may be a friends list provided by the messaging service. Examples of clients capable of displaying contact entries include IM clients integrated with a presence client with support for a friends or buddy list, email clients, SMS clients, and MMS clients with an integrated address book or contact list.

The system 200 shown in FIG. 2 includes a camera 202a, a personal computer (PC) 202b, and a mobile phone 202c, collectively referenced as sending devices 202. One or more of the sending devices 202 includes a messaging client 302 associated with a messaging service 204. FIG. 3 depicts a system 300 providing a detailed view of one of the sending devices, PC 202b, including its IM client 302. The IM client 302, as previously discussed, is enabled to present a set of contact entries. The user interface 400 shown in FIG. 4 depicts an exemplary display 402 of the PC 202b including an IM client status window 404. The camera 202a and the mobile phone 202c are, in the described embodiment, capable of providing functionally equivalent user interfaces using the relatively limited display and input capabilities each has with respect to the PC 202b. The IM client status window 404 includes a friends list pane 406 presenting a set of contact entries.

The PC 202b includes a processor, an operating system, and various input/output subsystems standard to typical PCs, and, thus not shown, providing a execution environment for the operation of the components shown, such as the IM client 302. The IM Client 302 includes a status graphical user interface (GUI) manager 304 capable of displaying the IM client status window 404 on a display 402 along with a friends list pane 406 for presenting a visual representation of a set of contact entries.

In order to obtain the set of contact entries presented in the friends list pane 406, the IM client 302 can authenticate a user of the IM Client 302 by sending authentication information over the network 206 to an authentication service 208 of the messaging service 204. The network 206 may include any suitable network or transmission medium, such as an Ethernet transmission system, a wireless network connection and associated transmission medium, an IEEE 802.11(a), (b), or (g) or Bluetooth transmission system, a wide-area network (WAN), a local-area network (LAN), the Internet, or an intranet.

The IM client 302 depicted in the system 300 sends authentication information associated with the user using any of a number of protocols compatible with the authentication service 206. In the described embodiment, the IM client 302 of the sending device, the PC 202b, uses a presence protocol supported by a presence protocol layer 306, to send the authentication information in a presence message to the authentication service 208 over the network 206 using a network protocol supported by a network protocol stack 310. The authentication information is received, in one embodiment, from the user of the IM client 302 by the status GUI manager 304, or is retrieved by the IM client 302 from persistent storage (not shown) where it has been stored since an earlier authentication and/or prior configuration. The status GUI manager 304 passes the authentication information to a principal status monitor 308 that passes the authentication information to a presence user agent (PUA) 310. The PUA 310 passes the authentication information to a presentity 312 that creates a publish message including the authentication information. The presentity 312 sends the publish message to authenticate the user of the IM client 302 to the messaging service 204 where an authentication service 208 receives the authentication information and accepts or rejects the authentication attempt based on identity information stored in an authentication database 210. Once authenticated, the presentity 312 is allowed to establish a session with a presence service 212.

Once a session is established between the presentity 312 and the presence service 212, a friends list monitor 314 sends a request to retrieve the friends list information of the authenticated user by sending one or more messages subscribing to presence information associated with a set of contacts having corresponding presence tuples stored by the presence service 210 in a presence database 214. The message or messages sent to subscribe to the presence information of the contacts having entries in the authenticated user's friends list are sent via a request or requests from the friends list monitor 314 to a watcher user agent (WUA) 316 that passes the request(s) to a watcher 318. The watcher 318 generates the message(s) to send to the presence service 210 to establish subscriptions that are stored in the presence database 214. The presence database 214, in the described embodiment, also provides storage for presence tuples associated with each of the contacts that correspond to a contact entry in the friends list of the user of the IM client 302. The messages for subscribing to the presence information associated with the set of contacts are sent via the presence protocol layer 306 as described for the transmission of the publish message earlier.

When subscriptions are established for contacts corresponding to contact entries in the friends list of the authenticated user of the IM client 302, the presence service 212 sends current presence information stored in the presence database 214 for each presence tuple associated with each contact entry in the friends list. The presence information is sent using messages including notify commands compatible with the presence protocol supported by the presence protocol layer 306. The presence information included in each message is received by the watcher 318 where the presence information includes a status and an identifier of a contact associated with a contact entry of the friends list. The watcher 318 passes the information to the friends list monitor 314 via the WUA 316. The friends list monitor 314 causes the status GUI manager 304 to present or update the friends list display 406 of the IM client status window 404 on the display 402 of the user interface 400 shown in FIG. 4.

In alternate embodiments, other protocols can be used for authentication and retrieval of contact entries. For example, techniques for authenticating a client or user to a web server using hypertext transfer protocol (HTTP) as the protocol for exchanging authentication information include requiring the client or user to provide a userid and password, a certificate, or a hash value. In yet another embodiment, a messaging client may use its native messaging protocol's authentication support for authentication with a message service, if any, for example, simple mail transfer protocol (SMTP) and post office protocol (POP) for email. Contact entries, in some embodiments, are stored locally on a sending device 202 including a messaging client or are retrieved from a remote server using a proprietary protocol, such as HTTP or other extensible markup language (XML) variants and messaging application programming interface (MAPI).

At block 104 of the method 100 the messaging client receives, via the messaging client's user interface, a selection of a contact entry. The selection is used to identify a contact from the set of contact entries presented.

For example, in the user interface 400, a contact entry selection is received via detecting a mouse click event on a presented contact entry of the friends list pane 406 by the status GUI manager 304. The selected contact entry can be associated with information identifying the corresponding contact. Examples of identifying information include the contact's IM name, email address, and/or MMS address. More than one contact entry selection can be received using standard user interface interaction, such as detecting selection via a mouse click while detecting a CTRL key or a SHIFT key is also being pressed.

In the PC 202b, the status GUI manager 304 displays a visual representation of the contact entries in the friends list via the friends list pane 406. The status GUI manager 304 also receives input identifying one or more selected contacts. Selection is made by a user, for example, using an input device such a mouse or other pointing device, or a keyboard. The input device signals an appropriate input driver of the PC's 202b I/O subsystem. The operating system receives and routes the input signal from the I/O subsystem to the GUI or windows manager that determines the widget of the friends list pane 406 associated with the input signal. The GUI manager sends an indication of the input to the component responsible for the widget, which in the described example is the status GUI manager 304. The status GUI manager 304 processes the input and determines which contact entry is selected or which contact entries are selected in the case of a multiple selection input.

At block 106 of the method 100, a service indication is received identifying a service to be made accessible to the contact identified in block 104. The service is typically a service of the sending device 202, but may be a service accessible to the sending device, e.g. PC 202b, such as a printer 222 on a LAN to which the sending device 202b is also connected. The identifier is received, for example, through a messaging client application program interface (API), from another application, e.g., printer service 320c shown in FIG. 3, in communication with the messaging client 302, or via a user interface 400 provided by the messaging client 302 allowing a user to select one or more services. The service(s) are not provided by the messaging service and authorization is required for performing a service for a contact.

Service, as used in this document, refers to an application or system and is also used to refer to a function of an application or system, such as displaying certain information, retrieving a resource, such as a file, allowing an upload of a resource, setting a value, and the like.

The exemplary system 300 shown in FIG. 3 is configured to receive an indication of a service to be made accessible to the contact of block 104 of the method 100. In an exemplary usage scenario, the user interface 400, when an input, such as right-click, is received that is associated with a contact entry presented on the friends list pane 406 by the status GUI manager 304, a context menu 408 can be displayed by the status GUI manager 304. An input associated with a selection of an exemplary “Invite” 408 menu item shown in the figure can be received by the status GUI manager 304, resulting in the display of a first exemplary submenu 410 by the status GUI manager 304. An input associated with the selection of a “Web . . . ” 412 menu item, as shown, can be received by the status GUI manager 304, resulting in the display of a second submenu 414. From the second submenu 414, an indicator that a photo service, providing access to photos stored on the PC 202b, is available is provided via the “Photos” 416 menu item shown in the figure. A selection of the “Photos” 416 menu item can be received by the status GUI manager 304, thus identifying the selected service.

In the embodiment described, presentation of the GUI components discussed is managed by status GUI manager 304 and input received, which is associated with the presented GUI components discussed, is received via one or more input devices through the I/O subsystem, operating system and window manager (not shown) previously discussed of the PC 202b, as is typical of PC devices and well-known to those skilled in the art. The window manager in the PC 202b passes an input to a component associated with presented widget associated with the input. The presented widgets are under the control of the status GUI manager 304 allowing the status GUI manager 304 to determine when a selection of a contact entry has been made and when a service indication has been received via a presented GUI component.

In the example described, the PC 202b includes a web service 320a that provides a platform for one or more web applications such as a photo-sharing web application 322a and other web application 322b, collectively referred to as the web applications 322. The web service 320a and the web applications 322 are registered with a services manager 324 of the IM client 302. In the embodiment of PC 202b depicted in FIG. 3, services register with the services manager 324 through an API provided by a plugin manager 326 of the IM client 302. The plugin manager 326 is communicatively coupled to the services manager 324. The web service 320a includes a plugin agent (PIA) 328a that communicates with the plugin manager 326 on behalf of the web service 320a and the web applications 322. The services manager 324 stores service information for each service in a registry 330. The content of service information can vary. In the system 300, for example, service information associated with a service includes a name for presenting in a context menu, an identifier uniquely identifying a service to the services manager 324, and a contact identifier, such as an event queue identifier, a URI of a publish-subscribe tuple, or a pointer to a callback interface. Service information, in some embodiments, includes at least a portion of a link for link generation, as described below.

Other services made available by PC 202b are registered similarly. Exemplary services depicted include a file system service 320b, providing access to at least a portion of the PC's 202b files and folders, a printer service 320c, providing access to at least a portion of the printing services available to the PC 202b, and a camera service 320d, providing access to at least a portion of the features and resources of a camera (not shown) that is integrated into or coupled to the PC 202b. The file system service 320b includes a share manager 332 for authorizing access to file system resources. Together, services 320a, 320b, 320c, and 320d are referred to as the services 320. The services 320 each are capable of communication with the plugin manager 326 via the depicted PIAs 328a-d collectively referred to as the PIAs 328. Each PIA 328 performs a function for its associated service 320 analogous to that described with respect to the PIA 328a described in conjunction with the web service 320a.

Other example services that may be provided by sending devices 202 conforming to an embodiment of the systems and methods described here include a communications service, a document service, an executable program to be accessed by the contact, a service remote from the messaging client, an audio service, a video service, a home security service, a printer service, a service for displaying information, a service for retrieving a resource, a service for providing upload of a resource, and a service for setting a value.

Continuing with the usage scenario being described, the PC's 202b window manager passes an input indicator received by the status GUI 304 associated with the processing of second submenu 414 of the user interface 400. The indicator enables the status GUI 304 to determine a selected menu item that is the “Photos” 416 menu item in the described usage scenario. The indicator is associated with the menu item that is built by the status GUI manager 304 using a record in the registry 330 corresponding to the service information associated with the photo-sharing web application 322a provided via web service 320a. The service information associated with photo-sharing web application 322a includes an indicator that authorization is required to view any part of the service. That is, web service 320a is configured to invoke photo-sharing application 322a to perform a requested operation that generates a view of the application 322a only when authorization is successful.

At this point in the usage scenario, the status GUI manager 304 passes the contact identification information of the selected contact entry and the indicated service, photo-sharing application 322a, to the service manager 324. The service manager 324 coordinates the activities required to enable the identified contact to access the indicated service allowing the contact to request the performing of at least one function/operation of the photo-sharing web application 322a.

Other embodiments support other techniques allowing a messaging client to be aware of an available service. For example, an equivalent to a service manager may scan a system for applications, services, and resources that may be made accessible to users. Service information may be provided, at least in part, by a user. A service manager can be integrated with a messaging client as in the system 300 in some embodiments and can be separate in other embodiments with communication enabled between the service manager and the messaging client.

At block 108 of the method 100, authorization information is generated and associated with the contact and the service. The generated authorization information allows the identified service to be performed when requested by the contact. In some embodiments, authorization information is associated with a contact and a plurality of services, a plurality of contacts and a service, and/or a plurality of contacts and a plurality of services. In other words, contacts and/or services, in some embodiments, are grouped for authorization purposes.

In the usage scenario, the service manager 324, upon receiving both a selected contact entry identifying a message address associated with a contact, for example “John,” and the indicated service, photo-sharing web application 322a, each having entries presented in display 400, retrieves service information associated with the photo-sharing web application 322a from the registry 330. The service manager 324 uses the service information to cause authorization information to be generated associated with the photo-sharing web application 322a and John for authorizing a performing of the photo-sharing web application 322a at a request of John. The authorization information in the described embodiment is based on service information associated with the photo-sharing web application 322a and information associated the contact entry for John. The authorization information can be generated in a number of ways. In one embodiment using the system 300, the service manager 324 generates the authorization information. For example, the authorization information can include a URI of the John's presence tuple and an identifier, such as at least a portion of a URL of the indicated service, web photo-sharing application 322a (e.g. myPhotos/shared of http://localhost/myPhotos/shared) and a permission providing one of a plurality of access levels, such as “readOnly”. The service manager 324 passes the authorization information to the identified service, photo-sharing web application 322a, or an agent of the service, such as web service 320a. The photo-sharing web application 322a or its agent creates or updates an access control list, in the described embodiment, for the service associated with the portion of the URL included as the authorization information. In the access control list, an access control record associated with the contact. John, identified by the presence URI included in the authorization information is created or updated and assigned the permission, “readOnly.” The authorization information is communicated from services manager 324 to its destination, the photo-sharing web application 322a, and/or the web service 320a, via the plugin manager 326 and the PIA 328a of the web service 320a in the current usage scenario.

Another embodiment may use a default authorization permission, or may provide a user interface for receiving user specified permission information. Permission information includes an access level, and may include a modifier such as a number of requests or sessions allowed, an expiration time, or other schedule related information. For example, an authorization options dialog 418 is depicted in the user interface 400 of FIG. 4 illustrating an exemplary user interface for receiving user specified permissions and associated modifiers. The authorization options dialog 418 illustrates that a user is able to cancel the request to make a service available to the contact and initiate the sending of a message enabling access to the service including an option allowing a user to provide a portion of the message to be sent.

In an embodiment, the authorization information may be determined by default permissions, as earlier indicated, provided by the indicated service. In the described embodiment, the authorization options 418 user interface allows for receiving customized authorization information from the user of the PC 202b. The authorization options dialog 418 depicted allows a user to customize the level of access provided to a contact for an indicated service. A selection of an input widget, such as a “Schedule” button, may be received that allows a user to customize the level of access provided to the contact based on configurable periods of time. Other input controls in authorization options dialog 418 include options for limiting access for a specified amount of time, a number of instances, and/or access levels, such as “read-only,” “write,” and/or “execute” access. Access and authorization may be permanent and/or unique to the user. Access and authorization may be shared by more than one receiver (e.g., a member of a group). In yet other embodiments, a status of the contact is used as at least a portion of the authorization information. For example, authorization is not granted if the contact's status does not indicate that the contact is “online”

In the usage scenario, the services manager 324 generates the authorization information as described and the identified service, the photo-sharing web application 322a, or an agent of the service, web service 320a, provides authorization services. In an alternate embodiment, a contact identifier, e.g., “John,” is sent to an indicated service where authorization information is generated by the service and stored for later access. In another embodiment, a service manager generates authorization information and stores it in its registry. The service manager can be either integrated into the messaging client or operate separately from the messaging client, and provides authorization services for at least one of the services made accessible to a contact by an associated messaging client. One skilled in the art can see that various combinations of these embodiments, as well as other embodiments, are possible for generating authorization information and for providing authorization services for enabling the method 100 shown in FIG. 1.

At block 110 of the method 100 a message for the contact identified by the selected contact entry is generated at the sending device. The message includes a link to the indicated service. The link allows the contact to locate or access the service when the contact receives the message. In some embodiments, at least a portion of the link may include a request to perform the service. In other embodiments, the link allows the user to access the service allowing the contact to make an explicit request to perform the service. The link may be, for example, a link to a web application, a downloadable application through which the contact may request the performing of the service, or the link itself may include a request to initiate a download service for downloading a resource, such as a file.

In the usage scenario, in the system 300 the service manager 324 requests an IM GUI manager 334 of IM client 302 to construct a message addressed to the contact, “John”. This occurs as a result of an input received via the authorization options 418 pane when a selection of a “Send” button is detected by the status GUI manager 304. The status GUI manager 304 invokes the IM GUI manager 334. The invocation includes a link, retrieved from or, generated based on the service information associated with the identified service, the photo-sharing web application 322a, and/or an agent for the service, the web service 320a. The invocation, in some embodiments, includes an indicator that an interface is to be provided for receiving additional message data from the user of the PC 202b. This can occur when an input associated with a selection of the “Message . . . ” button of the authorization options dialog 418 is detected by the status GUI manager 304. Upon receiving the request, the IM GUI manager 334 presents a user interface (not shown) allowing a user to add to the message, if indicated by the invocation. The IM GUI manager 334 creates a message, includes the link and any additional message data provided by the user, and addresses the message to the contact, “John”. The message, when received with the link, enables the “John” to access the identified service.

At block 112 of the method 100, the messaging client sends the message, using the messaging service, including the link to the contact or a device of the contact enabling the contact to retrieve the message. The contact is then enabled to use the link to access the service. The contact is authenticated to the service by the messaging service or an authentication service associated with the messaging service prior to performing the service for the contact. The authorization information generated in block 108 is used to authorize any requests for performing the service by the contact. In some embodiments, the service requests authentication of the contact by the messaging service or an authentication service associated with the messaging service upon detecting an access attempt. In other embodiments, the indicated service or an agent of the indicated service requests authentication of the contact by the messaging service or an authentication service associated with the messaging service upon detecting a request to perform the service. In still other embodiments, an access attempt and a request attempt are simultaneous. While in yet another embodiment, at least a portion of the link is used by the service to authenticate the contact assisted by the messaging service or an authentication service associated with the messaging service.

Authentication may be by a third party associated with the messaging service as already mentioned, or jointly by the service provider and the messaging service or an authentication service associated with the messaging service, as just suggested. If the request from the contact is transmitted by the messaging service, the contact may currently be authenticated by the messaging service, thus authentication is assumed by the indicated service, since the request is received over a trusted communication channel of the messaging service.

The system 200 including the PC 202b depicted in the system 300 is configured to send the message via the messaging service's 204 IM Service 216 to the contact. In the usage scenario, the message, when received by the contact, “John”, enables “John” to access the service, the photo-sharing web application 322a, using the link and request the performing of the service, where the generated authorization information is used to authorize the performing of the service. The performing of the service occurs after the contact, “John”, is authenticated by the messaging service 204 or an authentication service associated with or included in the messaging service, such as authentication service 208.

In the usage scenario, for example, the IM GUI manager 334 passes the message for “John” to an IM session manager 336 for further processing. The processing includes establishing a session with an IM service 216 using a message database 218 for storing configuration and runtime data in the system 200 and the system 300. The IM session manager 336 processes the message generating a representation suitable for passing to an IM agent 338. The IM agent 338 is enabled to communicate with an IM protocol layer 340 that sends the message using an IM protocol to the IM service 214 over network 210 using the network protocol stack 310.

The IM service 216 is configured to deliver the message to the identified contact, “John”, by transmitting the message to a device, such as a mobile phone 202c, where “John” is logged in (i.e. authenticated) to the messaging service 204 as indicated by the presence service 212. A messaging client of the mobile phone 202c is enabled to receive the message and present it including the link and any additional data provided by the user of the PC 202b to “John”. The contact, “John”, is enabled through use of the link to access the photo-sharing web service 322a via the web service 320a.

The access either implicitly includes a request to perform the service identified by the user of the PC 202b, such as a request to display a pre-identified photo-album, or the access causes an interface to be presented, such as a web page generated by photo-sharing web service 322a and transmitted to a browser (not shown) of the mobile phone device 202c by the web service 320a. The interface allows the contact, “John”, to explicitly request the performing of a service by the photo-sharing web service 322a such as displaying a photo album selected by the contact.

When a request to perform a service is detected by the service, the photo-sharing web application 322a, or its agent the web service 320a, the service or the agent ensure that the contact, “John”, is authenticated using, for example, one of the previously discussed techniques.

In an embodiment not yet discussed, the request is relayed through the messaging service 204 by a proxy such as proxy service 220 providing access to the PC 202b through a firewall 224. The proxy services 220 receives the request from the contact, communicates with the authentication service 208 to authenticate the contact, then sends the request to the messaging client of mobile phone 202c, along with an indication that the contact is authenticated. The indication may form a portion of the link modified by the proxy service 220 upon successful authentication of the contact. The proxy service 220, in another embodiment, communicates with the photo-sharing web service 322a or its agent, web service 320a via the sending device, PC 202b, using any number of authentication protocols in the process of cooperatively authenticating the request in conjunction with the PC 202b.

Once authenticated, the service or its proxy uses the generated authorization information to identify an associated record in an access control list associated with the requested service and the authenticated contact. The request is performed when a record is located and includes a permission allowing the request in the context of any modifiers present in the record. Otherwise, the request is denied. In the usage scenario, the contact, “John”, is authorized to request the performance of at least one service as identified in block 106 of the method 100.

In one embodiment, fees may be charged for providing access to a secure service via a link. For example, at least one of a message service provider and/or a sending device providing a service may charge a fee to one or more of the message sender, the receiver of the message, and any provider other than the entity charging the fee.

The executable instructions of a computer program for carrying out the method illustrated in FIG. 1 can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

According to one aspect of the present subject matter, a system for providing access to a secure service via a link in a message is provided. The system includes means for providing a messaging client associated with a messaging service operating on a sending device, wherein the messaging client includes a user interface that presents a set of contact entries. For example, as described above with respect to block 102, the system 200 depicting the sending device PC 202b, shown in detail in the system 300, includes the messaging service 204 client and IM client 302 that operate on the PC 202b. The IM client 302 presents a set of contact entries via a user interface, as illustrated by the friends list pane 406 in FIG. 4.

The system further includes means for receiving, via the messaging client user interface, a selection of a contact entry from the presented set of contact entries, where the selected contact identifies a contact. For example, as stated above with respect to block 104, the IM client 302 user interface 400 of the PC 202b receives a selection of a contact entry via an user input device, such as a keyboard or a mouse, coupled to the user interface 400.

The system further includes means for receiving an identification of a service to be made accessible to the contact, the service being provided by a provider other than the messaging service, wherein authorization is required for performing the service. For example, as described above with regard to block 106, the IM client 302 user interface 400 of the PC 202b receives an indication of a service via, for example, an input device, such as a keyboard or a mouse. The IM client 302 may present one or more menus, such as those illustrated in FIG. 4, to allow the user of the PC 202b to indicate the service.

The system further includes means for generating authorization information associated with the service and the contact for authorizing a performing of the service at a request of the contact. For example, as stated above with respect to block 108, the messaging service 204 client, IM client 302, of PC 202b, in one embodiment, generates authorization information that controls the level of access that a contact will have to the indicated service.

The system further includes means for generating a message at the sending device for the contact, the message including a link for enabling the contact to access the service. For example, as stated above with respect to block 110, the IM Client 302 of the PC 202b generates a message with a link to the indicated service, such as a web application, a downloadable application through which the contact may request the performing of the service, or a request to download a resource.

The system further include means for sending the message to the contact via the messaging service, enabling the contact to access the service using the link, and request the performing of the service, where the generated authorization information is used to authorize the performing of the service after the contact is authenticated by the messaging service. For example, as stated above with regard to block 112, the IM client 302 of the PC 202b sends the message including the link to the contact, such as the mobile phone 202c. In one example, when the contact associated with the mobile phone 202c attempts to access the indicated service using the link in the message, components of the messaging service 204, such as the authentication service 208 and/or the presence service 212, authenticate the user prior to the performing of the requested service.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for providing access to a secure service via a link in a message, the method comprising:
providing a messaging client associated with a messaging service operating on a sending device, wherein the messaging client includes a user interface that presents a set of messaging service contact entries;
receiving, via the user interface, a selection of a contact entry identifying a contact from the presented set of contact entries;
receiving an identification of a service to be made accessible to the contact, the service being provided by a provider other than the messaging service, wherein authorization is required for performing the service;
generating authorization information associated with the service and the contact for authorizing a performing of the service at a request of the contact;
generating a message at the sending device for the contact, the message including a link for enabling the contact to access the service; and
sending the message to the contact via the messaging service, enabling the contact to access the service using the link and request the performing of the service, wherein the generated authorization information is used to authorize the performing of the service after the contact is authenticated by the messaging service.

2. The method of claim 1 wherein providing a messaging client includes providing at least one of a presence client, a publish-subscribe client, an instant message (IM) client, a multimedia messaging service (MMS) client, a short messaging service (SMS) client, an email client, a video messaging client, and a voice messaging client.

3. The method of claim 1 wherein receiving a selection of a contact entry from the presented set of contact entries includes receiving a selection of more than one contact entry identifying corresponding contacts from the set of presented contact entries.

4. The method of claim 1 wherein receiving an identification of a service includes receiving identification of one at least one of a web service, a photo sharing service, a communications service, a document service, an executable to be accessed by the contact, a service remote from the messaging client, an audio service, a file system service, a camera service, a video service, a home security service, a printer service, a service for displaying information, a service for retrieving a resource, a service for providing upload of a resource, and a service for setting a value.

5. The method of claim 1 wherein generating authorization information includes generating authorization information configured to provide one of a plurality of access levels to the contact.

6. The method of claim 1 wherein generating authorization information includes generating authorization information configured to provide access to the contact based on at least one of a number of accesses, a predetermined period of time, a group including the contact, and a status of the contact.

7. The method of claim 1 wherein authenticating the contact by the messaging service includes authenticating the contact using at least one of a presence service and an authentication service associated with the messaging service.

8. The method of claim 1 wherein the authorization information associated with the service is included as at least a portion of the link and the link portion including the authorization information is used by the service to authorize the contact for the performing of the service for the contact.

9. The method of claim 1 wherein sending the message to the contact includes sending the message to the contact via one of a presence service, an instant messaging (IM) service, a multimedia messaging service (MMS), a short messaging service (SMS), an email service, and a voice messaging service.

10. The method of claim 1 comprising retrieving the set of contact entries from a remote server.

11. The method of claim 1 comprising retrieving presence information associated with the set of contact entries.

12. The method of claim 11 wherein sending the message to the contact includes sending the message to the contact based upon the presence information associated with the contact.

13. The method of claim 1 comprising storing the authorization information.

14. The method of claim 1 wherein enabling the contact to access the service includes enabling the contact to access the service via a proxy.

15. The method of claim 1 wherein enabling the contact to access the service includes enabling the contact to access the service through a firewall.

16. A system for providing access to a secure service via a link in a message, the system comprising:
a messaging client associated with a messaging service, the messaging client being configured to operate on a sending device, and wherein the messaging client includes a user interface that presents a set of messaging service contact entries, wherein the messaging client is configured to:
receive, via the user interface, a selection of a contact entry identifying a contact from the presented set of contact entries;
receive an identification of a service to be made accessible to the contact, the service being provided by a provider other than the messaging service, wherein authorization is required for performing the service;
generate authorization information associated with the service and the contact for authorizing a performing of the service at a request of the contact;
generate a message at the sending device for the contact, the message including a link for enabling the contact to access the service; and
send the message to the contact via the messaging service, enabling the contact to access the service using the link and request the performing of the service where the generated authorization information is used to authorize the performing of the service after the contact is authenticated by the messaging services.

17. The system of claim 16 wherein the messaging client comprises at least one of a presence client, a publish-subscribe client, an instant message (IM) client, a multimedia messaging service (MMS) client, a short messaging service (SMS) client, an email client, a video messaging client, and a voice messaging client.

18. The system of claim 16 wherein the messaging client is configured to receive a selection of more than one contact entry identifying corresponding contacts from the set of presented contact entries.

19. The system of claim 16 wherein the service to be made available to the contact includes at least one of a web service, a photo sharing service, a communications service, a document service, an executable to be accessed by the contact, a service remote from the messaging client, an audio service, a file system service, a camera service, a video service, a home security service, a printer service, a service for displaying information, a service for retrieving a resource, a service for providing upload of a resource, and a service for setting a value.

20. The system of claim 16 wherein the authorization information generated by the messaging client is configured to provide one of a plurality of access levels to the contact.

21. The system of claim 16 wherein the authorization information generated by the messaging client is configured to provide access to the contact based on at least one of a number of accesses, a predetermined period of time, a group including the contact, and a status of the contact.

22. The system of claim 16 wherein the contact is authenticated by the messaging service using at least one a presence service and an authentication service associated with the messaging service.

23. The system of claim 16 wherein the authorization information associated with the service is included as at least a portion of the link and the link portion including the authorization information is used by the messaging service to authenticate the contact for the performing of the service for the contact.

24. The system of claim 16 wherein the messaging client is configured to send the message to the contact via one of a presence service, an instant messaging (IM) service, a multimedia messaging service (MMS), a short messaging service (SMS), an email service, and a voice messaging service.

25. The system of claim 16 wherein the messaging client is configured to retrieve the set of contact entries from a remote server.

26. The system of claim 16 wherein the messaging client is configured to retrieve presence information associated with the set of contact entries.

27. The system of claim 26 wherein the messaging client is configured to send the message to the contact based upon the presence information associated with the contact.

28. The system of claim 16 wherein the messaging service is configured to store authorization information.

29. The system of claim 16 wherein the messaging service is configured to enable the contact to access the service via a proxy.

30. The system of claim 16 wherein the messaging service is configured to enable the contact to access the service through a firewall.

31. A system for providing access to a secure service via a link in a message, the system comprising:
means for providing a messaging client associated with a messaging service operating on a sending device, wherein the messaging client includes a user interface that presents a set of messaging service contact entries;
means for receiving, via the messaging client user interface, a selection of a contact entry identifying a contact from the presented set of contact entries;
means for receiving an identification of a service to be made accessible to the contact, the service being provided by a provider other than the messaging service, wherein authorization is required for performing the service;
means for generating authorization information associated with the service and the contact for authorizing a performing of the service at a request of the contact;
means for generating a message at the sending device for the contact, the message including a link for enabling the contact to access the service; and
means for sending the message to the contact via the messaging service, enabling the contact to access the service using the link and request the performing of the service where the generated authorization information is used to authorize the performing of the service after the contact is authenticated by the messaging service.

32. A computer readable medium containing a computer program, executable by a machine, for providing access to a secure service via a link in a message, the computer program comprising executable instructions for:
providing a messaging client associated with a messaging service operating on a sending device, wherein the messaging client includes a user interface that presents a set of messaging service contact entries;
receiving, via the messaging client user interface, a selection of a contact entry identifying a contact from the presented set of contact entries;
receiving an identification of a service to be made accessible to the contact, the service being provided by a provider other than the messaging service, wherein authorization is required for performing the service;
generating authorization information associated with the service and the contact for authorizing a performing of the service at a request of the contact;
generating a message at the sending device for the contact, the message including a link for enabling the contact to access the service; and
sending the message to the contact via the messaging service, enabling the contact to access the service using the link and request the performing of the service where the generated authorization information is used to authorize the performing of the service after the contact is authenticated by the messaging service.
